(19) United States
(12) Patent Application Publication
(10) Pub. No.: US 2020/0394254 A1
(43) Pub. Date: Dec. 17, 2020

(54) ESTABLISHING OBJECT ATTRIBUTE BELIEF FROM DIVERGENT DATA REPORTED BY SENSORS IN A NOISY ENVIRONMENT

(71) Applicant: The Boeing Company, Chicago, IL (US)

(72) Inventors: Haig Francis Krikorian, Fullerton, CA (US); Leo Ho Chi Hui, Alhambra, CA (US)

(73) Assignee: The Boeing Company, Chicago, IL (US)

(21) Appl. No.: 16/443,422

(22) Filed: Jun. 17, 2019

(51) Int. Cl. G06F 17/18

(52) U.S. Cl. CPC G06F 17/18

(57) ABSTRACT

A computer-implemented method may include receiving, from a respective plurality of sensor devices, a plurality of sensor belief datasets regarding attributes of an object; fusing the plurality of sensor belief datasets by applying covariance intersection; determining object attribute belief based on the fusing; and outputting information regarding the object attribute belief.

### BACKGROUND

An object detection sensor may detect an object by gathering data representing the object within the sensor's detection range/view, process the data, and report information regarding the sensor's prediction of the object's attributes and identity. Different object detection sensors may draw different conclusions as to the identification of a same object's attributes (e.g., as a result of noisy interfering environmental conditions, sensor design preferences for detecting certain emission properties, various scan rates, different object viewpoints and sensor positions, etc.). Conflict resolution techniques have been used to make a final determination as to the object's attributes. For example, if a majority of sensors draw the same conclusion as to the object's attributes, then the majority of sensors are “believed” and the object's attributes are presumed to be that as is identified by the majority of the sensors, whereas conclusions made by outlier sensors are ignored or discarded. As another example, object attributes may be estimated by averaging the results from multiple sensors. As a further example, object attributes from any sensor not matching a prescribed set of attributes are (often) automatically discarded.

### SUMMARY

In one example aspect, a computer-implemented method may include receiving, from a respective plurality of sensor devices, a plurality of sensor belief datasets regarding attributes of an object; fusing the plurality of sensor belief datasets by applying covariance intersection; determining object attribute belief based on the fusing; and outputting information regarding the object attribute belief

In another example aspect, a computing system, includes one or more processors; and a memory system comprising one or more non-transitory computer-readable media storing instructions that, when executed by at least one of the one or more processors, cause the computing system to perform operations. The operations may include receiving, from a respective plurality of sensor devices, a plurality of sensor belief datasets regarding attributes of an object; fusing the plurality of sensor belief datasets by applying covariance intersection; determining object attribute belief based on the fusing; and outputting information regarding the object attribute belief

In another example aspect, a non-transitory computer-readable medium may store instructions that, when executed by one or more processors of a computing system, cause the computing system to perform operations. The operations may include receiving, from a respective plurality of sensor devices, a plurality of sensor belief datasets regarding attributes of an object; fusing the plurality of sensor belief datasets by applying covariance intersection; determining object attribute belief based on the fusing; and outputting information regarding the object attribute belief.

### BRIEF DESCRIPTION OF THE DRAWINGS

FIG. 1 shows an example environment and overview in accordance with aspects of the present disclosure.

FIG. 2 shows an example flowchart of a process for establishing a belief consensus for identifying object attributes based on data from multiple different sensors in a noisy environment.

FIG. 3 illustrates an example of fusing data sensor belief data from multiple different sensor devices.

FIG. 4 illustrates established integrated belief output graphs based on processing sensor data from multiple different sensor devices.

FIG. 5 illustrates example components of a device that may be used within environment of FIG. 1.

### DETAILED DESCRIPTION

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

In an object detection system, multiple sensors may be provided and arranged to detect an object and its attributes (which may be used to identify the object). Example objects may include vehicles, aircraft, structures, or the like. In some situations, based upon each sensor's perspective, a majority of sensors may report a consensus of an object attribute belief (e.g., a belief or prediction of the object's attributes), however, the object's true attributes may differ from the belief that is reported by a majority of sensors. In other words, a belief or conclusion drawn by a single outlier sensor may, in fact, be the correct conclusion, whereas the conclusion drawn by the majority of other sensors may be incorrect. Further, the cost or repercussions of misclassifying/misidentifying an object's attributes (and hence, the object itself) may be considerable. Accordingly, aspects of the present disclosure may improve object detection accuracy by implementing a central node that acts as a “stable reasoner” to more accurately identify an object's attributes when distributed sensors, each indicating normal operation, identify the object's attributes differently, which may be of particular concern in noisy environments.

In some embodiments, the central node may provide an approach to develop a consensus of belief across independent sensor measurements reported by different sensors. Further, the central node may filter process noise that gave rise to the independent sensor measurements. As described herein, Covariance Intersection (CI) may be used to fuse estimates of the independent sensor measurements to ensure that the fused estimate error covariance matrix is not under-estimated, but is instead bounded. In some embodiments, a Kalman Filter is applied after the CI fusing to smooth, stabilize, and reduce noise from the CI fusing output, thereby resulting in a more accurate belief of the object's attributes. In this way, object identification is improved through the intelligent consideration of various factors and by considering each sensor's data as if it were true, and not simply based on data reported by a majority of sensors or by averaging sensor data.

As described herein, aspects of the present disclosure provide a real-time ranked fused belief with a confidence (e.g., fused covariance) so that downstream processing from the central node can apply the belief (e.g., determination of object attributes) to a taxonomy of relationships to determine the object types, assess their risk impact, and rank the objects to establish the next set of sensor commands. Any suitable downstream taxonomy-based belief assessment may be applied. As described herein, the central node may not simply and arbitrarily remove the beliefs from an outlier sensor. Instead, by recognizing that different mathematical techniques and different sensor perspectives can often lead to diametrically opposed results, aspects of the present disclosure, using the central node, may provide an approach to capture, assemble, resolve inconsistencies between sensor reports, and rank different attribute beliefs determined under noisy and time varying environmental conditions. In this way, object attribute identification is improved through the consideration of all beliefs reported by different sensors.

As described herein, aspects of the present disclosure may implement a particular configuration of sensors and a particular method of using the raw data from the sensors. By using and processing the raw sensor data in the manner described herein, object attribute detection is improved.

Embodiments of the disclosure may include a system, a method, and/or a computer program product at any possible technical detail level of integration. The computer program product may include a computer readable storage medium (or media) having computer readable program instructions thereon for causing a processor to carry out aspects of the present disclosure.

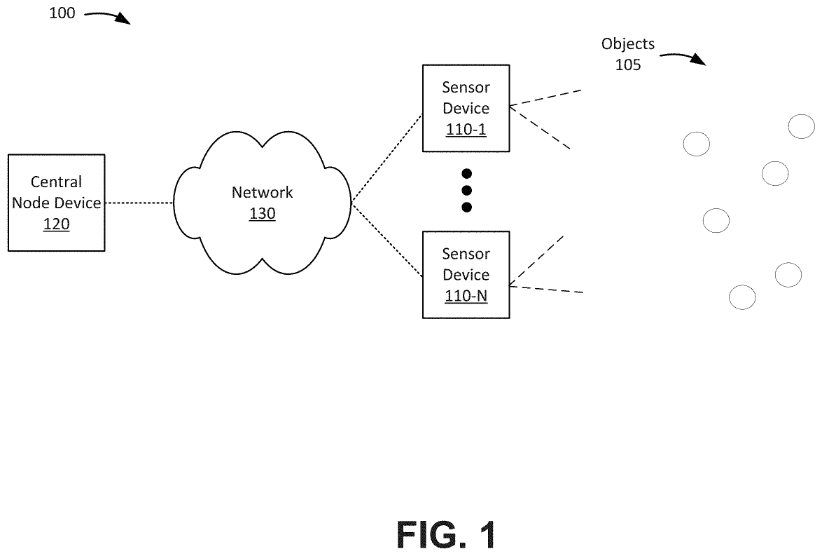

FIG. 1 shows an example environment and overview in accordance with aspects of the present disclosure. As shown in FIG. 1, environment 100 includes objects 105, sensor devices 110-1 through 110-N (where N is an integer greater than or equal to 2), a central node device 120, and a network 130.

The sensor devices 110 may include object sensor devices that may be distributed over an area for detecting objects 105 and their attributes. In some embodiments, the sensor devices 110 may gather raw data representing object emission properties, movement, etc. Each sensor device 110 may report, to the central node device 120, a “belief” or estimation of the object's attributes and/or identity based on the collected raw data (e.g., using any suitable combination of object prediction algorithms). In some embodiments, a reported belief may include a confidence level of the object's attributes. The confidence reported by each sensor device 110 may increase over a period of time as additional data is gathered until a belief is stabilized.

As described herein, multiple different sensor devices 110 may report divergent beliefs regarding an object's attributes as a result of environmental noise, sensor design preferences for detecting certain emission properties, various scan rates, different object viewpoints and sensor positions, etc. Accordingly, the central node device 120 may implement techniques to establish a consensus belief of the object's attributes. For example, the central node device 120 may establish a belief by implementing a “stable reasoner” approach that considers the beliefs of each of the sensor devices 110, even outliers. Further, the central node device 120 may determine a cause of unstable reportings from the sensor devices 110, and in turn, determine whether conclusions made by sensor devices 110 with unstable reportings should be believed. As described herein, the central node device 120 may filter and smooth sensor belief data (e.g., beliefs reported by the sensor devices 110) using, for example, a Kalman Filter. Further, the central node device 120 may fuse belief data from multiple sensors using Covariance Intersection (CI). In some embodiments, the CI output may be fused with sensor belief data from an additional sensor device 110, again using CI. This second CI output may be fused with sensor belief data from an additional sensor device 110 using CI, and so on and so forth. As further described herein, the central node device 120 may apply a Kalman Filter after fusing the data to further stabilize the data and improve belief accuracy. In this way, the central node device 120 may converge towards a belief that considers all of the beliefs reported by the sensor devices 110, without merely settling on an average of the data or a majority.

The network 130 may include one or more wired and/or wireless networks. For example, the network 130 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 130 may include a local area network (LAN), a wide area network (WAN), a metropolitan area network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the network 130 may include copper transmission cables, optical transmission fibers, wireless transmission, routers, firewalls, switches, gateway computers and/or edge servers.

The quantity of devices and/or networks in the environment 100 is not limited to what is shown in FIG. 1. In practice, the environment 100 may include additional devices and/or networks; fewer devices and/or networks; different devices and/or networks; or differently arranged devices and/or networks than illustrated in FIG. 1. Also, in some implementations, one or more of the devices of the environment 100 may perform one or more functions described as being performed by another one or more of the devices of the environment 100. Devices of the environment 100 may interconnect via wired connections, wireless connections, or a combination of wired and wireless connections.

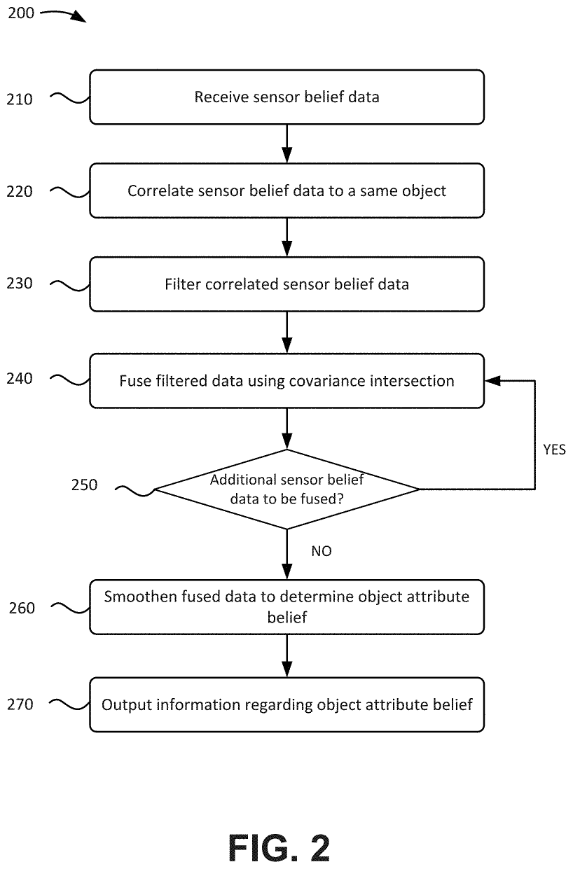

FIG. 2 shows an example flowchart of a process for establishing a belief consensus for identifying object attributes based on data from multiple different sensors in a noisy environment. The steps of FIG. 2 may be implemented in the environment of FIG. 2, for example, and are described using reference numbers of elements depicted in FIG. 2. As noted above, the flowchart illustrates the architecture, functionality, and operation of possible implementations of systems, methods, and computer program products according to various embodiments of the present disclosure.

As shown in FIG. 2, process 200 may include receiving sensor belief data (block 210). For example, the central node device 120 may receive sensor belief data from the sensor devices 110. In some embodiments, the sensor belief data may include raw sensor data gathered by the sensor devices 110 and/or information identifying the beliefs of object attributes reported by each of the sensor devices 110.

Process 200 may also include correlate sensor belief data to a same object (block 220). For example, the sensor belief data may include beliefs of attributes of different observed objects by the sensor devices 110 (e.g., objects 105 of FIG. 1). Accordingly, the central node device 120 may correlate or map the different belief data from the different sensor devices 110 to a same object such that attributes for a single object may be determined.

Process 200 may further include filtering the correlated sensor belief data (block 230). For example, the sensor device 110 may filter the correlated sensor belief data using a single-dimensional Kalman Filter and/or other filtering technique. In one or more alternative embodiments, each sensor device 110 may apply the Kalman Filter when reporting its sensor belief data (e.g., at block 210). In some embodiments, the correlated sensor belief data may be filtered to produce a smoothed estimate of a mean and covariance. Further, the Kalman Filter may be applied to calculate a posterior mean and covariance of a multivariate Gaussian distribution of a time sequence. As described herein, the calculated covariance may be used as the basis for establishing the degree of belief of an object's attribute (e.g., on a scale of 0-1, 0-100, or other scale). For example, the covariance may represent a measure of noise or uncertainty in a given hypothesis.

In some embodiments, a modified or variation of the Kalman Filter (or other type of filter) may be used to account for the complexity of noisy dynamic environments. For example, the Kalman Filter may be modified to compensate for an unknown priori covariance process noise by having the process noise be adapted to the measured inputs around nominal values. In this way, the sensor belief data, reported by the sensor devices 110, and the mean and variance may be smoothened. Further, estimated state variables may be determined by applying the Kalman Filter, in which the estimated state variables represent the smoothened or filtered sensor belief data.

Process 200 may also include fusing the filtered data using covariance intersection (block 240). For example, the central node device 120 may fuse the filtered data (e.g., from process block 230) by applying covariance intersection to fuse two sets of filtered sensor belief data. As described herein, applying the Covariance Intersection (CI) may be used to develop a consensus of belief across the independent measurements from each of the sensor devices 110, and fuses the process noise that gave rise to the independent measurement. More specifically, by applying the CI, the estimated state variables from the Kalman Filter (representing the smoothened or filtered sensor belief data) may be combined when the correlation between the state variables is unknown. In some embodiments, use of CI may ensure that the fused estimate error covariance matrix is not under-estimated, but instead, is bounded. In some embodiments, and as part of applying the CI, a weighting coefficient may be determined by minimizing the bounds. In some embodiments, an optimization algorithm to the CI may be used to reduce the fusing calculation time.

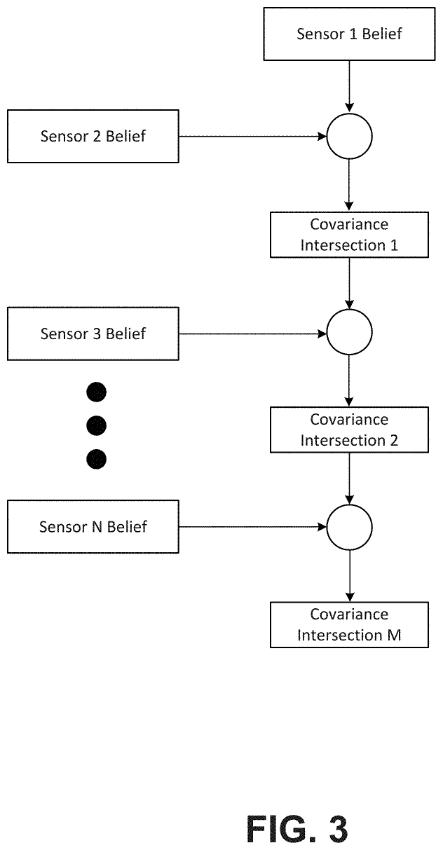

Process 200 may further include determining whether additional sensor belief data is to be fused (block 250). For example, block 240 may be repeated to fuse all sensor belief datasets with neighboring fused data. Additional details regarding the fusing of all sensor belief datasets is described in greater detail below with respect to FIG. 3.

Process 200 may also include smoothening the fused data to determine object attribute belief (block 260). For example, the central node device 120 may smoothen the fused data using the Kalman Filter, and/or other filtering technique. By applying the Kalman Filter after the fusing process, object attribute belief (e.g., a belief or perdition as to the object's attributes) may be determined or established based on a smoothened set of fused data, thereby improving object attribute estimation accuracy when different sensor devices 110 report different object attribute beliefs as a result of a noisy environment.

Process 200 may further include outputting information regarding the object attribute belief (block 270). For example, the central node device 120 may output information regarding the object attribute belief to any number of systems, user devices, or the like for downstream processing or for any variety of purposes. As the object attribute belief accuracy is improved, any systems that use or rely on the object attribute belief are, in turn, improved. In some embodiments, the central node device 120 may output information regarding the attribute belief in the form of a graph, a report, a chart, or other format that identifies attributes of the object.

In some embodiments, process 200 may be repeated for different objects observed by the sensor devices 110. For example, as described above with respect to process block 220, belief data is correlated to a same or single object. Accordingly, process 200 may be repeated to correlate belief data to a different object, whereby process steps 230-280 may be executed to establish a belief of object attributes for the different object. Also, blocks 210-240 may be applied to all data reported by sensor devices 110 at a given time, or be applied sequentially.

FIG. 3 illustrates an example of fusing data sensor belief data from multiple different sensor devices. In some embodiments, FIG. 3 may represent process blocks 240 and 250 from FIG. 2 to fuse multiple sensor belief datasets by applying CI. As shown in FIG. 3, two sensor belief datasets (e.g., sensor 1 belief and sensor 2 belief) may be fused by applying CI to form a first CI fused dataset (e.g., Covariance Intersection 1). In some embodiments, each sensor belief dataset may be filtered using the Kalman Filter prior to being fused such that the estimated state variables from the Kalman Filter (representing the smoothened or filtered sensor belief data) may be combined or fused via application of CI.

As further shown in FIG. 3, additional sensor belief datasets (e.g., sensor 3 belief through sensor N belief) may be fused by fusing the fused covariance intersection output with neighboring sensor belief datasets. As an example, sensor 3 belief may be fused with covariance intersection 1 to form covariance intersection 2. Sensor 4 belief may be used with covariance intersection 2 to form covariance intersection 3, and so on and so forth. In this way, sensor beliefs reported by multiple different sensor devices 110 may be fused as part of establishing a consensus belief across all sensor devices 110.

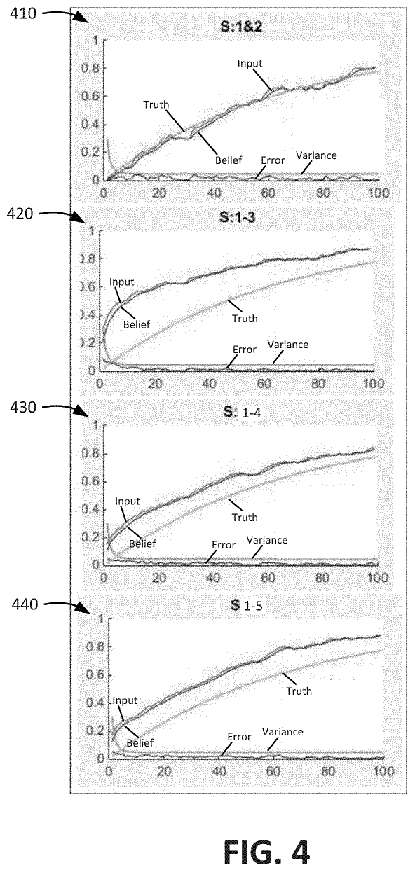

FIG. 4 illustrates established integrated belief output graphs based on processing sensor data from multiple different sensor devices. Graph 410 illustrates an established integrated belief based on fusing input belief data reported by two sensor devices 110 (e.g., S:1 and 2). Graph 420 illustrates an established integrated belief based on fusing input belief data reported by three sensor devices 110 (e.g., S:1-3). Graph 430 illustrates an established integrated belief based on fusing input belief data reported by four sensor devices 110 (e.g., S:1-4). Graph 440 illustrates an established integrated belief based on fusing input belief data reported by five sensor devices 110 (e.g., S:1-5). The graphs in FIG. 4 depict the incremental improvement in belief from successively incorporating the various sensor reports. The first integration shown in graph 410 depicts the improved belief from combining two sensor devices 110 (S:1) and (S:2). Integrating sensor device 110 (S:3) as shown in graph 420, the apparent outlier, pulls the CI fused belief away from truth, but only to a modest extent. Further incorporation of sensor devices 110 (S:4) as shown in graph 430 and (S:5) as shown in graph 440 not only mitigates this “bump” as a result of the outlier (S:3), but also delivers a smoothed belief output for improving for downstream processing. As a result, a reduction in both the covariance and belief error for a given attribute is realized by performing covariance intersection followed by smoothing via a Kalman Filter over that in comparison to covariance and belief error from a belief reported by an individual sensor device 110. It is this reduction in the error and resulting covariance that represents more accurate object attribute identification, which supports and improves stable downstream processing that use attribute identification.

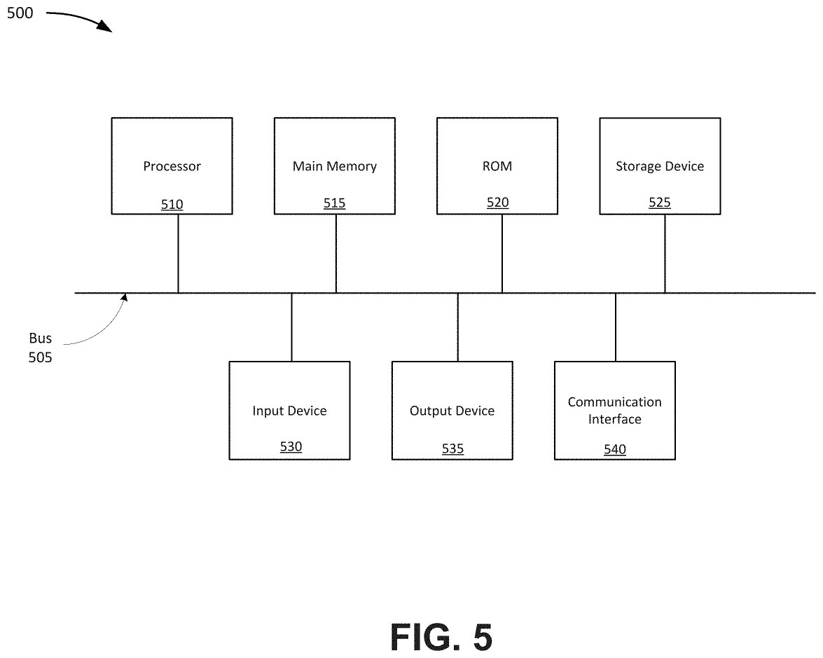

FIG. 5 illustrates example components of a device 500 that may be used within environment 100 of FIG. 1. Device 500 may correspond to the sensor devices 110 and/or the central node device 120. Each of the sensor devices 110 and/or the central node device 120 may include one or more devices 500 and/or one or more components of device 500.

As shown in FIG. 5, device 500 may include a bus 505, a processor 510, a main memory 515, a read only memory (ROM) 520, a storage device 525, an input device 530, an output device 535, and a communication interface 540.

Bus 505 may include a path that permits communication among the components of device 500. Processor 510 may include a processor, a microprocessor, an application specific integrated circuit (ASIC), a field programmable gate array (FPGA), or another type of processor that interprets and executes instructions. Main memory 515 may include a random-access memory (RAM) or another type of dynamic storage device that stores information or instructions for execution by processor 510. ROM 520 may include a ROM device or another type of static storage device that stores static information or instructions for use by processor 510. Storage device 525 may include a magnetic storage medium, such as a hard disk drive, or a removable memory, such as a flash memory.

Input device 530 may include a component that permits an operator to input information to device 500, such as a control button, a keyboard, a keypad, or another type of input device. Output device 535 may include a component that outputs information to the operator, such as a light emitting diode (LED), a display, or another type of output device. Communication interface 540 may include any transceiver-like component that enables device 500 to communicate with other devices or networks. In some implementations, communication interface 540 may include a wireless interface, a wired interface, or a combination of a wireless interface and a wired interface. In embodiments, communication interface 540 may receive computer readable program instructions from a network and may forward the computer readable program instructions for storage in a computer readable storage medium (e.g., storage device 525).

Device 500 may perform certain operations, as described in detail below. Device 500 may perform these operations in response to processor 510 executing software instructions contained in a computer-readable medium, such as main memory 515. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 515 from another computer-readable medium, such as storage device 525, or from another device via communication interface 540. The software instructions contained in main memory 515 may direct processor 510 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 500 may include additional components, fewer components, different components, or differently arranged components than are shown in FIG. 5.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A computer-implemented method comprising:
receiving, from a respective plurality of sensor devices, a plurality of sensor belief datasets regarding attributes of an object;
fusing the plurality of sensor belief datasets by applying covariance intersection;
determining object attribute belief based on the fusing; and
outputting information regarding the object attribute belief.

2. The computer-implemented method of claim 1, further comprising filtering the plurality of sensor belief datasets prior to fusing the plurality of sensor belief datasets.

3. The computer-implemented method of claim 1, further comprising filtering the plurality of sensor belief datasets after fusing the plurality of sensor belief datasets.

4. The computer-implemented method of claim 3, wherein the filtering the plurality of sensor belief datasets comprises using a Kalman Filter.

5. The computer-implemented method of claim 1, further comprising determining a covariance of the plurality of sensor belief datasets, wherein the fusing is based on the covariance.

6. The computer-implemented method of claim 1, wherein the plurality of sensor belief datasets comprises different beliefs regarding the attributes of the object.

7. The computer-implemented method of claim 1, further comprising correlating the plurality of sensor belief datasets to the object, wherein the fusing is based on the correlating.

8. A computing system, comprising:
one or more processors; and
a memory system comprising one or more non-transitory computer-readable media storing instructions that, when executed by at least one of the one or more processors, cause the computing system to perform operations, the operations comprising:
receiving, from a respective plurality of sensor devices, a plurality of sensor belief datasets regarding attributes of an object;
fusing the plurality of sensor belief datasets by applying covariance intersection;
determining object attribute belief based on the fusing; and
outputting information regarding the object attribute belief.

9. The computing system of claim 8, wherein the operations further comprise filtering the plurality of sensor belief datasets prior to fusing the plurality of sensor belief datasets.

10. The computing system of claim 8, wherein the operations further comprise filtering the plurality of sensor belief datasets after fusing the plurality of sensor belief datasets.

11. The computing system of claim 10, wherein the filtering the plurality of sensor belief datasets comprises using a Kalman Filter.

12. The computing system of claim 8, wherein the operations further comprise determining a covariance of the plurality of sensor belief datasets, wherein the fusing is based on the covariance.

13. The computing system of claim 8, wherein the plurality of sensor belief datasets comprises different beliefs regarding the attributes of the object.

14. The computing system of claim 8, wherein the operations further comprise correlating the plurality of sensor belief datasets to the object, wherein the fusing is based on the correlating.

15. A non-transitory computer-readable medium storing instructions that, when executed by one or more processors of a computing system, cause the computing system to perform operations, the operations comprising:
receiving, from a respective plurality of sensor devices, a plurality of sensor belief datasets regarding attributes of an object;
fusing the plurality of sensor belief datasets by applying covariance intersection;
determining object attribute belief based on the fusing; and
outputting information regarding the object attribute belief.

16. The computer-readable medium of claim 15, wherein the operations further comprise filtering the plurality of sensor belief datasets prior to fusing the plurality of sensor belief datasets.

17. The computer-readable medium of claim 15, wherein the operations further comprise filtering the plurality of sensor belief datasets after fusing the plurality of sensor belief datasets.

18. The computer-readable medium of claim 17, wherein the filtering the plurality of sensor belief datasets comprises using a Kalman Filter.

19. The computer-readable medium of claim 15, wherein the operations further comprise determining a covariance of the plurality of sensor belief datasets, wherein the fusing is based on the covariance.

20. The computer-readable medium of claim 15, wherein the plurality of sensor belief datasets comprises different beliefs regarding the attributes of the object.
